(19) United States
(12) Patent Application Publication
(10) Pub. No.: US 2007/0065585 A1
(43) Pub. Date: Mar. 22, 2007

(54) Reducing electrical resistance in electrolessly deposited copper interconnects

(76) Inventors: Ramanan V. Chebiam, Hillsboro, OR (US); Arnel Fajardo, Beaverton, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/233,297

(22) Filed: Sep. 21, 2005

(51) Int. Cl. B05D 1/32; B05D 3/04

(52) U.S. Cl. 427/282; 427/532; 427/304

(57) ABSTRACT

A method of forming an electrolessly deposited copper interconnect while reducing its electrical resistance comprises providing a substrate having a dielectric layer, wherein a trench portion including at least two sidewall surfaces and a bottom surface is etched into the dielectric layer, depositing a copper seed layer onto the substrate and within the trench portion, attaching a layer of a metal catalyst to the substrate and within the trench portion using a coupling agent, applying ultraviolet radiation to the trench portion to detach the metal catalyst from the sidewall surfaces and the bottom surface of the trench portion, activating the metal catalyst that remains attached to the substrate, performing an electroless plating process to deposit copper into the trench portion, and planarizing the deposited copper to form an interconnect. The result is a copper interconnect that is not contaminated with a metal catalyst that may increase its electrical resistance.

### BACKGROUND

In the manufacture of integrated circuits, copper interconnects are generally formed on a semiconductor substrate using a copper damascene process. In this process, a trench is etched into a dielectric layer and the trench is filled with a barrier layer and a seed layer. For instance, a physical vapor deposition (PVD) sputter deposition process may be used to deposit a tantalum nitride and tantalum barrier layer into the trench. This may be followed by a PVD sputter process to deposit a copper seed layer into the trench. Generally, an electroplating process is then used to fill the trench with copper metal to form the interconnect. As device dimensions scale down, however, the trenches used to form interconnects become more narrow and issues start to arise in the copper seeding and electroplating processes. For instance, problems such as trench overhang tend to occur that pinch off the trench opening and cause voids to appear within the copper interconnect.

To avoid the issues that electroplating deposition presents, an electroless deposition process may be used to deposit copper into the narrow trenches. An electroless deposition process deposits a metal from a solution (e.g., an electroless plating bath) onto a substrate by a controlled chemical reduction reaction in the absence of an external electric current. Electroless deposition processes offer more scalability than electroplating because electroless processes can deposit metal directly onto barrier materials without an intervening seed layer. Furthermore, electroless deposition processes have the ability to plate on thin copper seed layers without terminal effects as seen with electroplated copper.

For copper interconnects, a typical electroless process includes cleaning the semiconductor substrate, covalendy attaching a metal catalyst to the substrate surface, activating the metal catalyst, and depositing the metal into the trench using an electroless process. Unfortunately, the metal needed to catalyze the electroless deposition process can cause the electrical line resistance of the copper interconnect to increase. The metal catalyst becomes an impurity in the copper metal, and it is believed that this impurity disrupts the flow of electrons in the copper metal, thereby causing electron scattering and leading to a measurable increase in resistance. In some cases, this increase in electrical resistance of the copper interconnect can be as much as ten percent. The presence of the metal catalyst on the copper seed layer may also prevent grain growth in the electrolessly deposited copper. As such, improved electroless deposition processes for copper interconnects are needed.

### BRIEF DESCRIPTION OF THE DRAWINGS

FIG. 1 is a palladium immobilization process.

FIG. 2 illustrates a coupling agent and a metal catalyst.

FIGS. 3A to 3F illustrate an electroless deposition process.

FIG. 4 is a method of forming a copper interconnect in accordance with an implementation of the invention.

FIGS. 5A to 5G illustrate the method described in FIG. 4.

### DETAILED DESCRIPTION

Described herein are systems and methods of reducing electrical resistance in copper interconnects formed by conventional electroless deposition processes. In the following description, various aspects of the illustrative implementations will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative implementations. However, it will be apparent to one skilled in the art that the present invention may be practiced without the specific details. In other instances, well-known features are omitted or simplified in order not to obscure the illustrative implementations.

Various operations will be described as multiple discrete operations, in turn, in a manner that is most helpful in understanding the present invention, however, the order of description should not be construed to imply that these operations are necessarily order dependent. In particular, these operations need not be performed in the order of presentation.

Implementations of the invention enable the formation of copper interconnects having a reduced electrical resistance relative to conventional copper interconnects. The novel copper interconnects of the invention are formed using an electroless deposition process. The electroless deposition process utilizes a palladium immobilization process (PIP) whereby a palladium catalyst is used to facilitate the electroless deposition process. In accordance with implementations of the invention, ultraviolet radiation is used to remove the palladium catalyst from portions of a substrate where the copper interconnects are to be formed. It is believed that ultraviolet radiation breaks the bond that affixes the palladium catalyst to the substrate. Removing the palladium catalyst prevents the palladium from contaminating the copper metal and increasing the electrical line resistance of the copper interconnects.

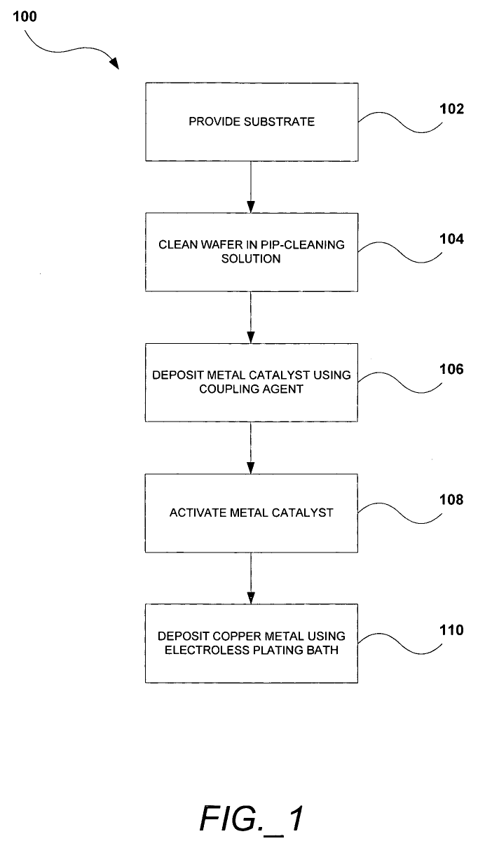

FIG. 1 is a conventional palladium immobilization process (PIP) 100 for initiating an electroless deposition process. The PIP process 100 begins by providing a semiconductor substrate onto which a copper interconnect may be formed (102). For instance, the semiconductor substrate may be a semiconductor wafer that includes a dielectric layer on its surface. The dielectric layer may include at least one trench in which the copper interconnect may be formed.

The substrate may be cleaned to remove impurities, contaminants, and/or oxides (104). The cleaning solution used may be an alkaline solution or a pure water rinse. The cleaning solutions may contain surfactants (e.g. polyoxyethylene derivatives), phosphates, and/or carbonates in alkaline media. These cleaning solutions tend to make the semiconductor substrate more hydrophilic and tend to remove loose particles due to the fluid motion on the wafer.

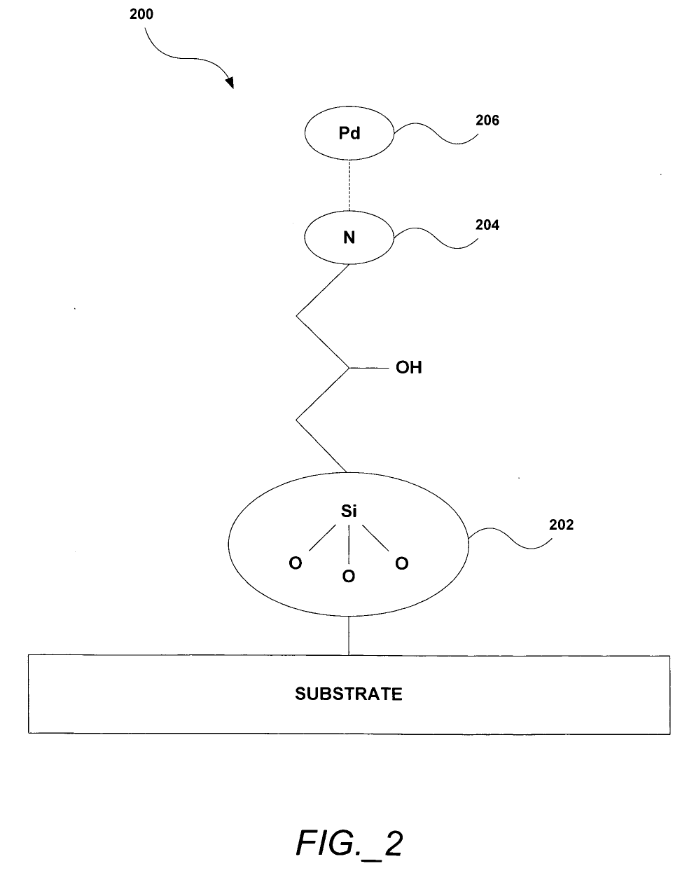

After the cleaning process, a metal catalyst is deposited onto the substrate using a coupling agent (106). Turning to FIG. 2, an exemplary coupling agent 200 is shown. The coupling agent may include a silane group 202, which has the ability to bond strongly to many different types of substrates, including semiconductor substrates. The coupling agent may also include a nitrogen group 204, which has the ability to bond to the metal catalyst. The nitrogen group 204 may be provided by an amine or azo group. For instance, in the implementation shown, the coupling agent 200 may be an azo-silane molecule and the nitrogen group 204 may be provided by an azo group. A metal catalyst 206 may bond to the nitrogen 204 of the coupling agent 200. In the implementation shown in FIG. 2, the metal catalyst is palladium metal. In alternate implementations, the metal catalyst 206 may be another metal, including but not limited to ruthenium, iridium, rhenium, rhodium, or osmium.

The coupling agent 200 and the metal catalyst 206 may be applied using any one of a variety of techniques including, but not limited to, wet or dry chemical vapor deposition (CVD). In one implementation, the substrate may be immersed in a single solution containing both the coupling agent 200 and the metal catalyst 206. In another implementation, the coupling agent 200 and the metal catalyst 206 may be provided in separate solutions, and the substrate may be separately immersed in each solution. When the substrate is immersed, the coupling agent 200, such as the azo-silane molecule, attaches to the substrate with the silane group bonded to the substrate and the azo group exposed. The metal catalyst 206, such as the palladium metal, bonds to the nitrogen in the exposed azo group. This results in the formation of a layer of metal catalyst ions over the nitrogen.

Returning to FIG. 1, the metal catalyst is then activated after bonding to the substrate (108). As is well known in the art, the metal catalyst may be activated by exposing the metal to a reducing agent. When activated, the metal catalyst may covalendy bond to the nitrogen group of the coupling agent. A monolayer of activated metal catalyst is now affixed to the surface of the substrate. The underlying nitrogen acts as an immobilizing structure which holds the metal catalyst in place on the substrate. The substrate may then be immersed in a plating bath and an electroless deposition process may be carried out to deposit metal, such as copper, over the metal catalyst (110). In some implementations, a spray technique may be used to carry out the electroless deposition process in lieu of an immersion technique.

The metal catalyst generally serves one of two purposes in most electroless deposition processes. In some electroless processes, the metal catalyst may serve as a nucleation site for the electroless deposition to occur. For instance, metals such as tantalum or titanium serve as poor nucleation sites for the electroless deposition of copper metal. For an electroless deposition of copper to occur on these surfaces, a metal catalyst such as palladium may be affixed to the tantalum or titanium using a coupling agent. The palladium may then function as a nucleation site for the electroless deposition of copper metal to occur.

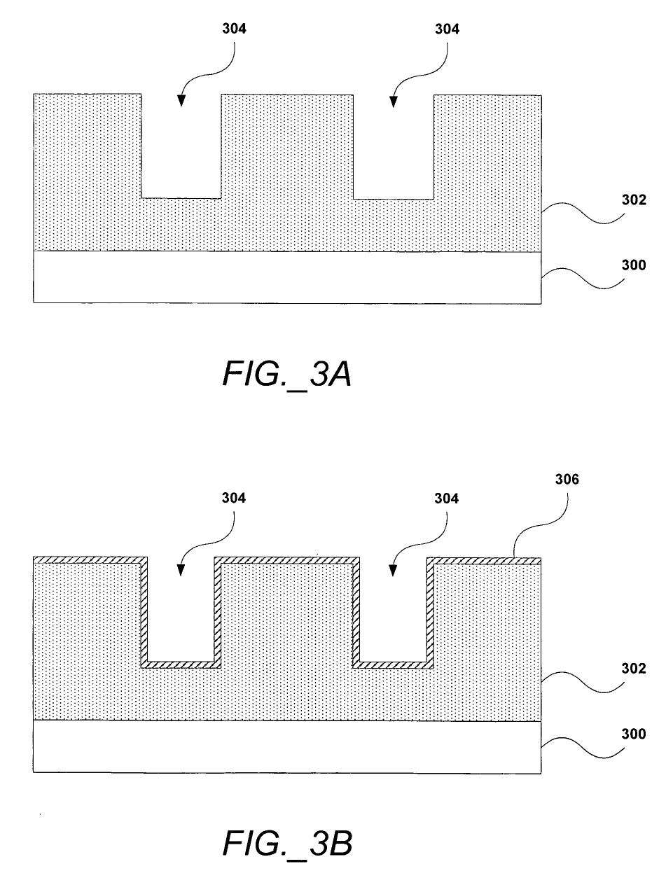

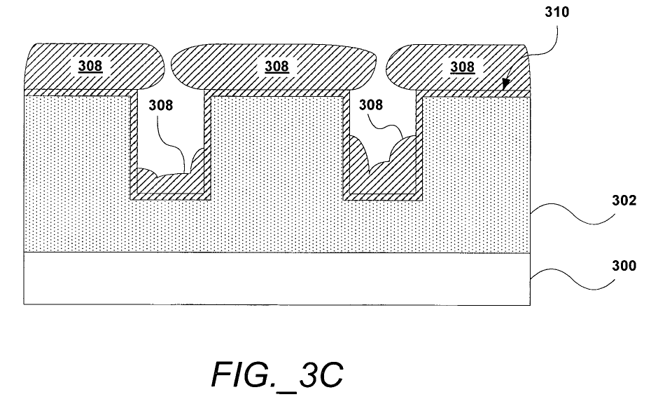

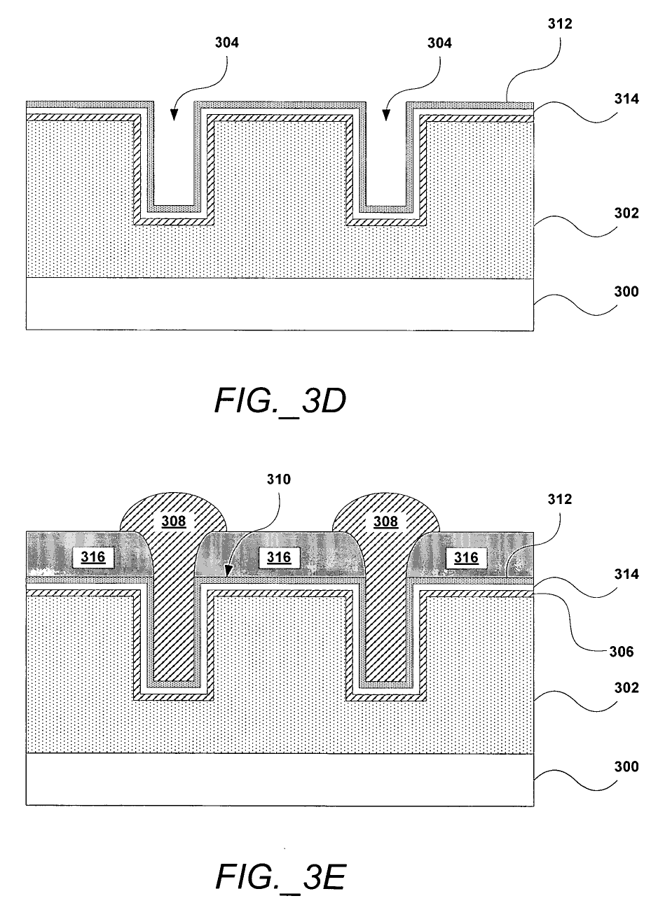

In this and other electroless processes, the metal catalyst may also function as an anchoring site for polymeric additives that are used to promote gap fill, particularly when high-aspect ratio gaps are being filled. This is explained in the illustrations of FIGS. 3A to 3F. Starting with FIG. 3A, a substrate 300 may be provided that includes a dielectric layer 302 that has been etched to form trenches 304. The trenches 304 may have a high-aspect ratio. As shown in FIG. 3B, a copper seed layer 306 may be deposited onto the substrate 300 to serve as a nucleation site for the electroless deposition of copper metal. The copper seed layer 306 may be deposited using known processes such as physical vapor deposition (PVD) or CVD. Although not shown, a barrier layer, such as a tantalum or tantalum nitride layer, may be deposited before the copper seed layer 306 as is well known in the art.

FIG. 3C illustrates what would happen if an electroless deposition process were to be carried out at this point. As shown, copper metal 308 that is deposited by the electroless process tends to deposit primarily on a top surface 310 of the substrate 300. The copper metal 308 generally avoids traveling down into the high-aspect ratio trenches 304 and often gets deposited on the top surface 310 before it even has an opportunity to travel down into the trenches 304. The result of this process is poor gap fill and incomplete copper interconnects.

To overcome this issue, a polymeric additive may be added to the plating bath used in the electroless deposition process. The polymeric additive has the ability to suppress the deposition of copper metal on the top surface 310 of the substrate 300 when it is anchored to the top surface 310 by a metal catalyst. Suppressing metal deposition on the top surface forces the metal ions to travel down into the narrow trenches where they deposit and fill the gap. The polymeric additive generally does not inhibit metal deposition within the features, such as the narrow trenches, as the high molecular weight of the polymer substantially prevents it from entering such features. In some implementations the polymeric additive may be present in the electroless plating solution, while in other implementations the polymeric additive may be deposited prior to the plating step. Accordingly, turning to FIG. 3D, a metal catalyst 312 may be affixed to the surface of the copper seed layer 306 using a coupling agent 314. The metal catalyst 312 serves as an anchoring site for the polymeric additive.

Next, as shown in FIG. 3E, an electroless plating process may be carried out using the plating bath with a polymeric additive 316. The polymeric additive 316 becomes deposited on the metal catalyst 312 and prevents copper metal 308 from depositing onto the top surface 310 of the substrate 300. The copper metal 308 must travel down into the trenches 304 where it can deposit on the copper seed layer 306 and the metal catalyst 312. The polymeric additive 316 therefore promotes gap fill by suppressing copper deposition on the top surface 310.

A critical shortcoming with the process described in FIGS. 3A to 3E is that the metal catalyst 312 coats the entire copper seed layer 306, including the bottom and sides of the trenches 304. It is believed that the presence of the metal catalyst 312, such as palladium, within the narrow trenches 304 causes the resistance of the subsequently formed copper interconnects to increase. As described above, the palladium or other metal catalyst may become embedded within the copper metal 308 and cause electron scattering within the interconnect.

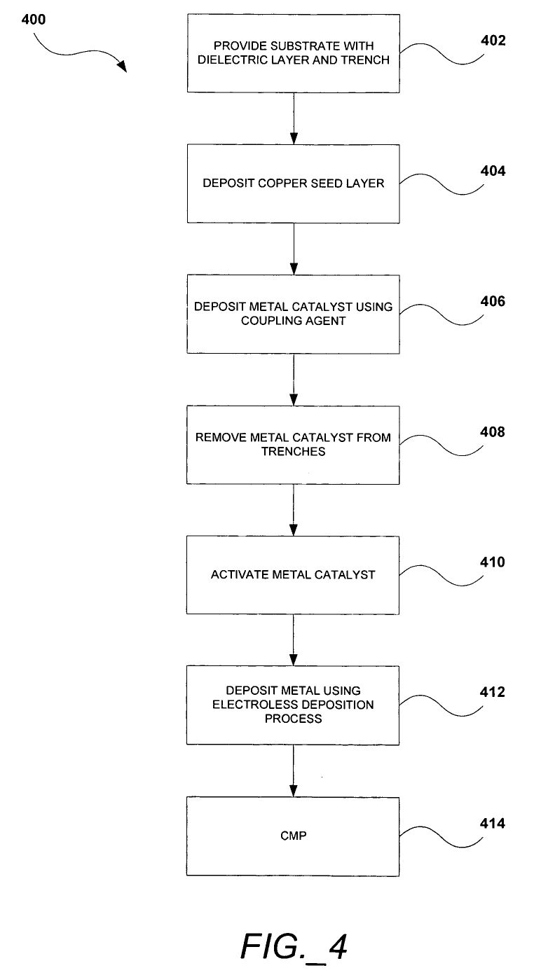

Accordingly, FIG. 4 is a method 400 of forming a copper interconnect in accordance with an implementation of the invention. The method 400 of the invention addresses the issue of the metal catalyst contaminating the copper interconnect. First, a substrate is provided upon which a copper interconnect may be formed (402). The substrate may be formed using a bulk silicon or a silicon-on-insulator (SOI) substructure. In other implementations, the substrate may be formed using alternate materials, which may or may not be combined with silicon, that include but are not limited to germanium, indium antimonide, lead telluride, indium arsenide, indium phosphide, gallium arsenide, or gallium antimonide. Although a few examples of materials from which the substrate may be formed are described here, any material that may serve as a foundation upon which a semiconductor device may be built falls within the spirit and scope of the present invention.

The substrate may include a dielectric layer formed on a surface of the substrate. The dielectric layer is generally used as an interlayer dielectric (ILD). Example of dielectric materials that may be used to form the dielectric layer include, but are not limited to, silicon dioxide (SiO₂), carbon doped oxide (CDO), organic polymers such as perfluorocyclobutane (PFCB), and fluorosilicate glass (FSG). The dielectric layer may include one or more trenches that have been etched into the dielectric layer. The trenches may be etched using well known photolithography techniques. It is within the trenches that the copper interconnects will be formed.

A copper seed layer may be deposited on the substrate (404). The copper seed layer is a very thin layer of copper metal that serves as a nucleation site for the electroless deposition of copper metal. The copper seed layer may be deposited using well known processes for depositing seed layers, including but not limited to chemical vapor deposition (CVD), plasma enhanced chemical vapor deposition (PECVD), physical vapor deposition (PVD), sputter deposition, and atomic layer deposition (ALD).

The substrate with the copper seed layer is then processed to deposit a coupling agent and a metal catalyst to the substrate (406). In some implementations, the substrate may be immersed in a solution that contains the coupling agent and the metal catalyst. In other implementations, the coupling agent and the metal catalyst may be provided in separate solutions, and the substrate may be immersed in each of the solutions separately. In one implementation, the coupling agent may be an azo-silane molecule and the metal catalyst may be palladium. The process to attach the metal catalyst to the substrate may be a PIP process, as described above. In other implementations, alternative coupling agents and metal catalysts may be used.

The metal catalyst generally forms a monolayer that covers substantially the entire surface of the copper seed layer, including the sidewalls and bottom of the trenches. As described above, the metal catalyst may degrade the performance of the subsequently formed copper interconnect. As such, in accordance with implementations of the invention, the metal catalyst and the coupling agent are then removed from within the trenches (408).

In some implementations, the metal catalyst and the coupling agent are removed using ultraviolet radiation. It is believed that ultraviolet radiation breaks the bond that affixes the metal catalyst to the substrate, thereby rendering the coupling agent inactive. For instance, in one implementation, ultraviolet radiation with a wavelength between 190 nanometers (nm) and 200 nm, and at a dose between 1 joule/cm² (J/cm²) and 10 J/cm², may be used to break the bond between the silane group and the azo group. More specifically, the silicon-carbon bond is broken to form silicon hydroxide. When this bond is broken, the azo group, as well as the metal catalyst bonded to the azo group, become detached from the surface of the substrate and may be removed. Therefore, when ultraviolet radiation is applied within the trenches, the azo groups and metal catalyst become detached from the sidewalls and bottom of the trenches and may then be removed. This reduces or prevents the occurrence of electron scattering by the metal catalyst which would otherwise remain in the trench and contaminate the later formed copper interconnect.

In accordance with the invention, the ultraviolet radiation may have a wavelength that ranges from 10 nm to 400 nm, and more preferably ranges from 190 nm to 200 nm. The radiation dose may range from 1 J/cm² to 30 J/cm², and more preferably ranges from 1 J/cm² to 10 J/cm². The ultraviolet radiation exposure may be restricted solely to the trench portions of the substrate by employing a mask or another similar device. Such a mask may be designed to only allow the ultraviolet radiation to expose the trenches while shielding the remainder of the substrate from the ultraviolet radiation. A mask similar to masks used in photolithography processes may be used. In other implementations, alternate devices such as shutters may be employed.

After the trenches are exposed to ultraviolet radiation, the metal catalyst may be activated (410). As described above, the metal catalyst may be activated by exposing the metal to a reducing agent. In the case of palladium, the reducing agent may be a hypophosphite compound or a derivative thereof. When activated, the metal catalyst may covalendy bond to the nitrogen group of the coupling agent and a monolayer of activated metal catalyst is now affixed to the surface of the substrate in all areas except within the trenches. The underlying nitrogen immobilizes the metal catalyst.

The substrate may then be immersed in a plating bath and an electroless deposition process may be carried out to deposit metal, such as copper, into the trenches over the copper seed layer (412). The copper seed layer, which becomes exposed when the metal catalyst is removed from the trenches, serves as a nucleation site for the electroless plating process. By removing the metal catalyst from the trenches, the copper metal may deposit in the trenches and grain growth will not be inhibited.

The electroless plating bath contains a polymeric additive that promotes gap fill by suppressing copper deposition on the top surface of the dielectric layer. The metal catalyst serves as an anchoring agent on the top surface of the dielectric layer to prevent the polymeric additive from going into the trench.

Finally, a chemical mechanical polishing (CMP) process may be used to remove excess metal after the deposition process (414). The CMP process planarizes the overall structure, thereby completing the formation of the copper interconnect structure.

The method 400 described in FIG. 4 may also include one or more cleaning steps. For example, the substrate may be cleaned prior to the electroless plating deposition process using a simple pure water rinse or a mildly acidic solution. The substrate may also be cleaned after the ultraviolet radiation exposure to remove the metal catalyst from the trenches. In some implementations, however, the bath used for the metal catalyst activation process may indirectly remove the metal catalyst from the trenches.

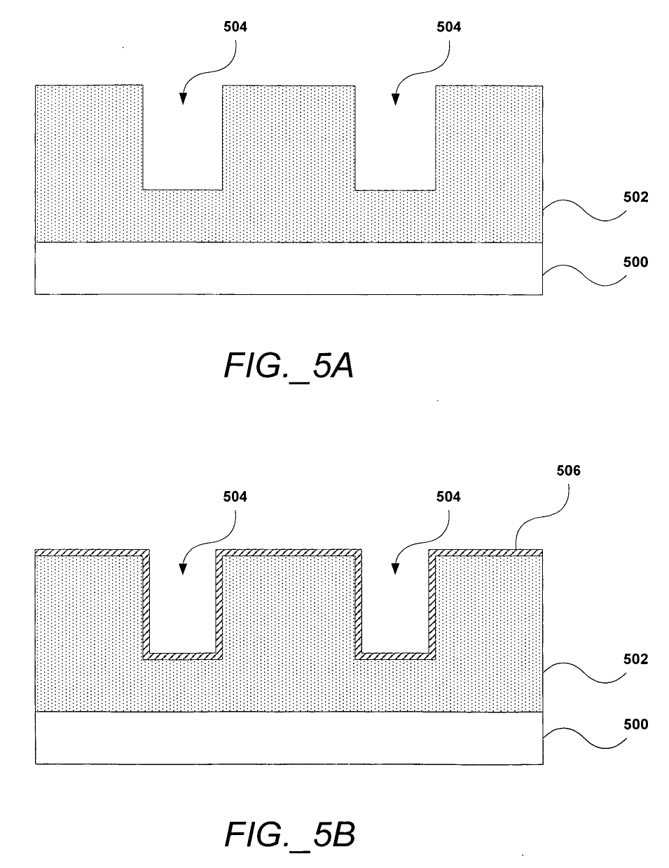

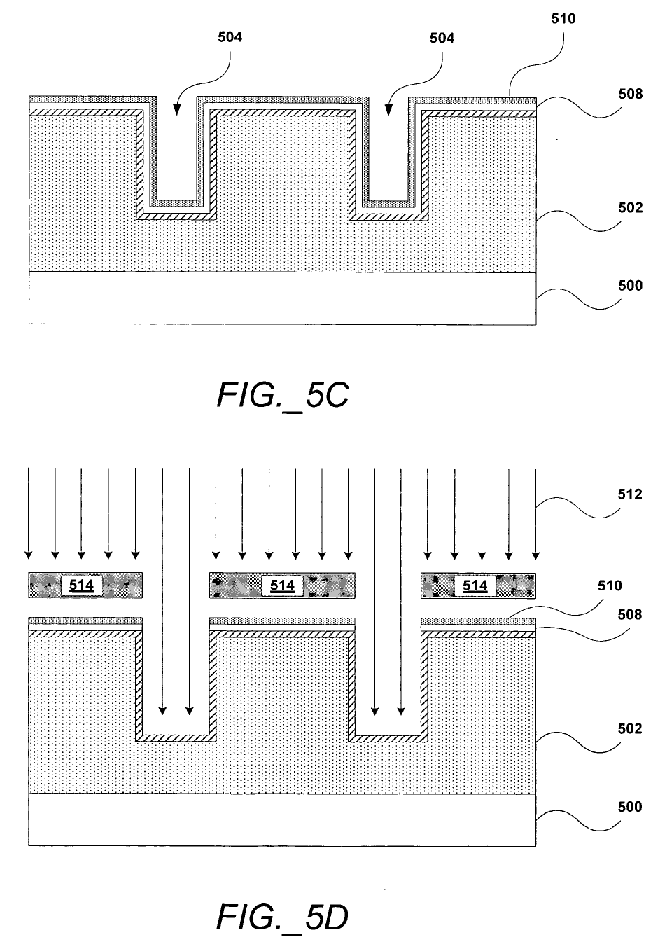

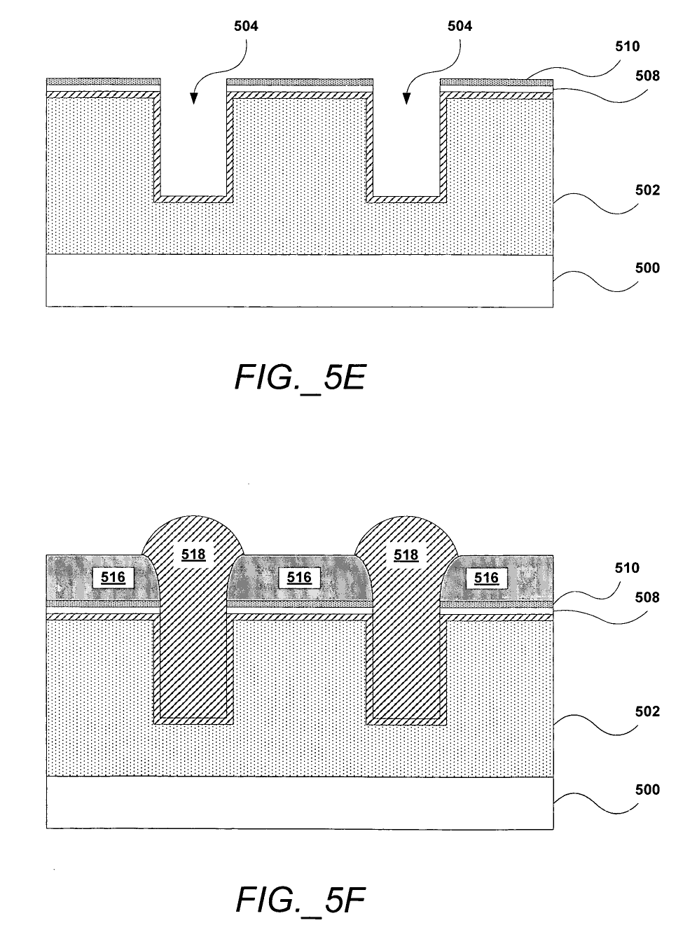

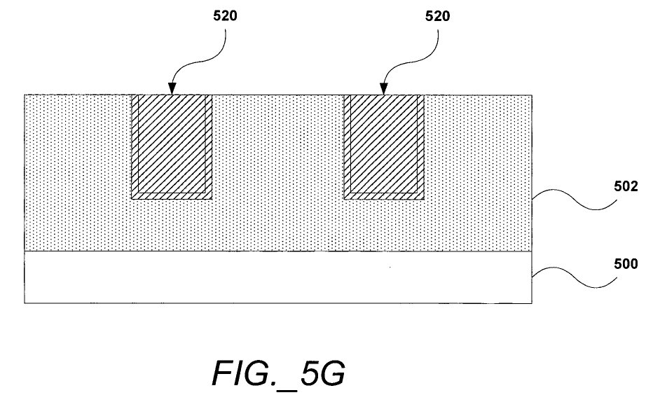

FIGS. 5A to 5G illustrate the method of forming a copper interconnect described in FIG. 4. Starting with FIG. 5A, a substrate 500 is provided upon which a copper interconnect may be formed. The substrate 500 may be formed using a bulk silicon, an SOI substructure, or alternate materials. The substrate 500 may also include a dielectric layer 502 formed on a surface of the substrate 500. The dielectric layer may include one or more trenches 504 that have been etched into the dielectric layer 502.

Turning the FIG. 5B, a copper seed layer 506 may be deposited on the substrate 500. As before, the copper seed layer 506 is a very thin layer of copper metal that serves as a nucleation site for the electroless deposition of copper metal. Although not shown, a barrier layer, such as a tantalum or tantalum nitride layer, may be deposited before the copper seed layer 506 as is well known in the art.

In FIG. 5C, a coupling agent 508 and a metal catalyst 510 are deposited on the substrate 500. In some implementations, the coupling agent 508 may be an azo-silane molecule and the metal catalyst 510 may be palladium. As shown, the metal catalyst 510 covers substantially the entire surface of the copper seed layer 506, including the sidewalls and bottoms of the trenches 504.

In FIG. 5D, ultraviolet radiation 512 is applied to the trenches 504 of the substrate 500 to detach the metal catalyst 510 from the sidewalls and bottoms of the trenches 504 and render the coupling agent 508 inactive. A photolithography mask 514 is used to restrict the ultraviolet radiation exposure to just the trenches 504. As shown, the coupling agent 508 and the metal catalyst 510 are removed from the sidewalls and bottom of the trenches 504.

Turning to FIG. 5E, the metal catalyst 510 may be activated. Again, the metal catalyst may be activated by exposing the metal to a reducing agent. The metal catalyst may now be covalently bonded to the nitrogen group of the coupling agent and a monolayer of activated metal catalyst is now affixed to the surface of the substrate in all areas except within the trenches. The underlying nitrogen immobilizes the metal catalyst.

In FIG. 5F, the electroless plating deposition process begins. The plating bath includes a polymeric additive 516 to promote gap fill. As shown in FIG. 5F, the polymeric additive 516 becomes anchored to the top surface of the dielectric layer 502 by the metal catalyst 510 while the copper metal 518 becomes deposited within the trenches 504 over the copper seed layer 506. The copper metal 518 is prevented from depositing on the top surface of the dielectric layer 502 by the polymeric additive 516. Finally, as shown in FIG. 5G, a CMP process may be used to remove excess metal and planarize the structure, completing the formation of one or more copper interconnects 520.

Accordingly, a method for forming electrolessly deposited copper interconnects that are not contaminated by a metal catalyst has been disclosed. The presence of the metal catalyst is maintained on the field where it can anchor a high molecular-weight polymeric additive and prevent polymer diffusion into the trenches. The metal catalyst, however, is eliminated from the trenches where the catalyst might otherwise adversely affect the electrical resistance of the later formed copper interconnects. In some instances, it has been shown that removing palladium metal catalyst in this manner can decrease the electrical line resistance of electrolessly deposited copper interconnects by approximately ten percent.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize.

These modifications may be made to the invention in light of the above detailed description. The terms used in the following claims should not be construed to limit the invention to the specific implementations disclosed in the specification and the claims. Rather, the scope of the invention is to be determined entirely by the following claims, which are to be construed in accordance with established doctrines of claim interpretation.

1. A method comprising:
providing a substrate;
depositing a copper seed layer onto the substrate;
depositing a layer of a metal catalyst onto the copper seed layer using a coupling agent;
exposing a first portion of the substrate to ultraviolet radiation to remove the metal catalyst from the first portion;
activating the remaining metal catalyst; and
depositing a metal onto the first portion.

2. The method of claim 1, wherein the substrate comprises a silicon wafer and includes a dielectric layer.

3. The method of claim 1, wherein the copper seed layer is deposited using a chemical vapor deposition process, a plasma enhanced chemical vapor deposition process, a physical vapor deposition process, a sputter deposition process, or an atomic layer deposition process.

4. The method of claim 1, wherein the metal catalyst and the coupling agent are deposited onto the copper seed layer using a chemical vapor deposition process or a wet chemical solution process.

5. The method of claim 1, wherein the metal catalyst is selected from the group consisting of palladium, ruthenium, iridium, rhenium, rhodium, and osmium.

6. The method of claim 1, wherein the coupling.agent comprises a silane group and a nitrogen group.

7. The method of claim 6, wherein the coupling agent comprises an azo-silane molecule.

8. The method of claim 1, wherein the ultraviolet radiation has a wavelength between 10 nm to 400 nm and a radiation dose between 1 J/cm² to 30 J/cm².

9. The method of claim 1, the ultraviolet radiation has a wavelength that is greater than or equal to 190 nm and less than or equal to 200 nm, and a radiation dose that is greater than or equal to 1 J/cm² and less than or equal to 10 J/cm².

10. The method of claim 1, wherein the exposing of the first portion of the substrate to ultraviolet radiation comprises utilizing a photolithography mask to expose the first portion to the ultraviolet radiation and to shield the remainder of the substrate from the ultraviolet radiation.

11. The method of claim 1, wherein the activating of the remaining metal catalyst comprises exposing the remaining metal catalyst to a reducing agent.

12. The method of claim 11, wherein the reducing agent comprises a hypophosphite compound.

13. The method of claim 1, wherein the metal comprises copper.

14. The method of claim 1, wherein the depositing of the metal onto the first portion comprises using an electroless plating process to deposit the metal onto the first portion.

15. The method of claim 14, wherein the electroless plating process uses a plating bath that includes a polymeric additive to promote gap fill.

16. A method comprising:
providing a substrate having a dielectric layer, wherein a trench portion including at least two sidewall surfaces and a bottom surface is etched into the dielectric layer;
depositing a copper seed layer onto the substrate and within the trench portion;
attaching a layer of a metal catalyst to the substrate and within the trench portion using a coupling agent;
applying ultraviolet radiation to the trench portion to detach the metal catalyst from the sidewall surfaces and the bottom surface of the trench portion;
activating the metal catalyst that remains attached to the substrate;
performing an electroless plating process to deposit a metal into the trench portion; and
planarizing the deposited metal to form an interconnect.

17. The method of claim 16, wherein the copper seed layer is deposited using a chemical vapor deposition process, a plasma enhanced chemical vapor deposition process, a physical vapor deposition process, a sputter deposition process, or an atomic layer deposition process.

18. The method of claim 16, wherein the metal catalyst is selected from the group consisting of palladium, ruthenium, iridium, rhenium, rhodium, and osmium.

19. The method of claim 16, wherein the coupling agent comprises an azo-silane molecule.

20. The method of claim 16, wherein the ultraviolet radiation has a wavelength between 10 nm to 400 nm and a radiation dose between 1 J/cm² to 30 J/cm².

21. The method of claim 16, wherein the applying of ultraviolet radiation to the trench portion comprises utilizing a mask to expose the trench portion to the ultraviolet radiation and to shield the remainder of the substrate from the ultraviolet radiation.

22. The method of claim 16, wherein the activating of the metal catalyst that remains attached to the substrate comprises exposing the metal catalyst to a hypophosphite compound.

23. The method of claim 16, wherein the metal comprises copper.

24. The method of claim 16, wherein the performing of an electroless plating process comprises performing an electroless plating process using a plating bath that includes a polymeric additive to promote gap fill.

25. The method of claim 16, wherein the planarizing of the deposited metal comprises performing a chemical mechanical polishing process.

26. An apparatus comprising:
a substrate having a dielectric layer, wherein a trench is etched into the dielectric layer;
a metal catalyst affixed to portions of the substrate;
a copper seed layer disposed within the trench; and
a metal deposited in the trench by an electroless plating process to form an interconnect, wherein substantially none of the metal catalyst contaminates the metal.

27. The apparatus of claim 26, wherein the substrate comprises a silicon wafer.

28. The apparatus of claim 26, wherein the metal comprises copper.

29. The apparatus of claim 26, wherein the metal catalyst is selected from the group consisting of palladium, ruthenium, iridium, rhenium, rhodium, and osmium.

30. The apparatus of claim 26, wherein ultraviolet radiation was used to remove the metal catalyst from within the trench before the metal was deposited by the electroless plating process.
